(19) United States
(12) Patent Application Publication
(10) Pub. No.: US 2024/0406815 A1
(43) Pub. Date: Dec. 5, 2024

(54) METHOD AND APPARATUS FOR LAYER1/LAYER2 TRIGGERED MOBILITY (LTM) OPERATIONS

(71) Applicant: FG Innovation Company Limited, Tuen Mun (HK)

(72) Inventors: CHIA-HUNG LIN, Taipei (TW); MEI-JU SHIH, Taipei (TW); WAN-CHEN LIN, Taipei (TW); CHIA-HSIN LAI, Taipei (TW)

(21) Appl. No.: 18/734,420

(22) Filed: Jun. 5, 2024

Related U.S. Application Data
(60) Provisional application No. 63/506,347, filed on Jun. 5, 2023.

(51) Int. Cl. H04W 36/00; H04W 36/08

(52) U.S. Cl. CPC H04W 36/0072; H04W 36/08

(57) ABSTRACT

A method for a User Equipment (UE) for performing a Layer1/Layer2 Triggered Mobility (LTM) operation is provided. The UE receives a target Transmission Configuration Indicator (TCI) state configuration and an LTM cell switch command indicating a target cell. The UE switches from the source cell to the target cell and applies a TCI state in the target cell. The TCI state is associated with the target TCI state configuration. The LTM cell switch command indicates the TCI state among a first set of TCI states in a case that the UE receives an LTM TCI state activation command. The LTM cell switch command indicates the TCI state among a second set of TCI states and activates the TCI state in a case that the UE does not receive the LTM TCI state activation command. The first set of TCI states is a subset of the second set of TCI states.

### CROSS-REFERENCE TO RELATED APPLICATION(S)

The present application claims the benefit of and priority to U.S. Provisional patent application Ser. No. 63/506,347, filed on Jun. 5, 2023, entitled “METHODS FOR SUPPORTING BEAM ACTIVATION, INDICATION AND RECOVER DURING LTM PROCEDURE,” the content of which is hereby incorporated herein fully by reference into the present disclosure for all purposes.

### FIELD

The present disclosure is related to wireless communication and, more specifically, to User Equipment (UE), Base Station (BS), and method for Layer1/Layer2 Triggered Mobility (LTM) operations in the cellular wireless communication networks.

### BACKGROUND

Various efforts have been made to improve different aspects of wireless communication for the cellular wireless communication systems, such as the 5th Generation (5G) New Radio (NR), by improving data rate, latency, reliability, and mobility. The 5G NR system is designed to provide flexibility and configurability to optimize network services and types, accommodating various use cases, such as enhanced Mobile Broadband (eMBB), massive Machine-Type Communication (mMTC), and Ultra-Reliable and Low-Latency Communication (URLLC). As the demand for radio access continues to increase, however, there exists a need for further improvements in the next-generation wireless communication systems.

### SUMMARY

The present disclosure is related to a UE, a BS, and a method for an LTM operation in cellular wireless communication networks.

In a first aspect of the present application, a method for a UE for performing an LTM operation is provided. The method includes receiving, from a source cell, a target Transmission Configuration Indicator (TCI) state configuration corresponding to a target cell; receiving, from the source cell, an LTM cell switch command via a first Medium Access Control (MAC) Control Element (CE), the LTM cell switch command indicating the target cell; switching from the source cell to the target cell; and applying a TCI state in the target cell. The TCI state is associated with the target TCI state configuration. The LTM cell switch command indicates the TCI state among a first set of TCI states in a case that the UE receives an LTM TCI state activation command. The LTM cell switch command indicates the TCI state among a second set of TCI states and activates the TCI state in a case that the UE does not receive the LTM TCI state activation command. The first set of TCI states is a subset of the second set of TCI states.

In some implementations of the first aspect, the method further includes receiving, from the source cell, multiple candidate cell configurations. Each of the candidate cell configurations includes a candidate TCI state configuration. The target cell corresponds to one of the candidate cell configurations.

In some implementations of the first aspect, the TCI state is applied no later than a time duration after the last symbol of a Physical Uplink Control Channel (PUCCH) or a Physical Uplink Shared Channel (PUSCH) with Hybrid Automatic Repeat Request-Acknowledgement (HARQ-ACK) information of a Physical Downlink Shared Channel (PDSCH) providing the LTM cell switch command.

In some implementations of the first aspect, the second set of TCI states includes all TCI states configured in the target TCI state configuration.

In some implementations of the first aspect, the LTM TCI state activation command is received via a second MAC CE, and the LTM TCI state activation command activates the first set of TCI states among all TCI states configured in the target TCI state configuration.

In some implementations of the first aspect, the LTM TCI state activation command is received before the LTM cell switch command is received.

In some implementations of the first aspect, the target TCI state configuration comprises a parameter for indicating a separate TCI mode or a joint TCI mode.

In a second aspect of the present application, a UE for performing an LTM operation is provided. The UE includes at least one processor and at least one non-transitory computer-readable medium that is coupled to the at least one processor and that stores one or more computer-executable instructions. The computer-executable instructions, when executed by the at least one processor, cause the UE to: receive, from a source cell, a target TCI state configuration corresponding to a target cell; receive, from the source cell, an LTM cell switch command via a first MAC CE, the LTM cell switch command indicating the target cell; switch from the source cell to the target cell; and apply a TCI state in the target cell. The TCI state is associated with the target TCI state configuration. The LTM cell switch command indicates the TCI state among a first set of TCI states in a case that the UE receives an LTM TCI state activation command. The LTM cell switch command indicates the TCI state among a second set of TCI states and activates the TCI state in a case that the UE does not receive the LTM TCI state activation command. The first set of TCI states is a subset of the second set of TCI states.

In a third aspect of the present application, a BS for configuring an LTM operation is provided. The BS includes at least one processor and at least one non-transitory computer-readable medium that is coupled to the at least one processor and that stores one or more computer-executable instructions. The computer-executable instructions, when executed by the at least one processor, cause the BS to: transmit, via a source cell, to a UE, a target TCI state configuration corresponding to a target cell; and transmit, via the source cell, to the UE, an LTM cell switch command via a first MAC CE. The LTM cell switch command indicates the target cell and enables the UE to switch from the source cell to the target cell and to apply a TCI state in the target cell. The TCI state is associated with the target TCI state configuration. The LTM cell switch command indicates the TCI state among a first set of TCI states in a case that the UE receives an LTM TCI state activation command. The LTM cell switch command indicates the TCI state among a second set of TCI states and activates the TCI state in a case that the UE does not receive the LTM TCI state activation command. The first set of TCI states is a subset of the second set of TCI states.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 is a flowchart illustrating a method/process for a UE for performing an LTM operation, according to an example implementation of the present disclosure.

FIG. 2 is a flowchart illustrating a method/process performed by a BS for configuring the LTM, according to an example implementation of the present disclosure.

FIG. 3 is a block diagram illustrating a node for wireless communication, according to an example implementation of the present disclosure.

### DESCRIPTION

Some abbreviations used in the present disclosure include:

| Abbreviation | Full name |
|---|---|
| 3GPP | 3^{rd} Generation Partnership Project |
| 5G | 5^{th} Generation |
| ACK | Acknowledgment |
| BS | Base Station |
| BWP | Bandwidth Part |
| CA | Carrier Aggregation |
| CC | Component Carrier |
| CG | Configured Grant |
| CHO | Conditional Handover |
| CJT | Coherent Joint Transmission |
| CRC | Cyclic Redundancy Check |
| CSI-RS | Channel State Information Reference Signal |
| DAPS | Dual Active Protocol Stack |
| DC | Dual Connectivity |
| DCI | Downlink Control Information |
| DL | Downlink |
| DM-RS | Demodulation Reference Signal |
| DU | Distributed Unit |
| E-UTRA | Evolved Universal Terrestrial Radio Access |
| FR | Frequency Range |
| HARQ | Hybrid Automatic Repeat Request |
| HARQ-ACK | HARQ Acknowledgement |
| HO | Handover |
| ID | Identifier |
| IE | Information Element |
| L1/L2/L3 | Layer 1/Layer 2/Layer 3 |
| LTE | Long Term Evolution |
| MAC | Medium Access Control |
| MAC CE | MAC Control Element |
| MCG | Master Cell Group |
| MCS | Modulation Coding Scheme |
| MN | Master Node |
| mTRP | Multi-TRP |
| NAS | Non Access Stratum |
| NR | New Radio |
| NW | Network |
| NZP | Non-Zero Power |
| OFDM | Orthogonal Frequency Division Multiplexing |
| PCell | Primary Cell |
| PCI | Physical Cell Identifier |
| PDCCH | Physical Downlink Control Channel |
| PDSCH | Physical Downlink Shared Channel |
| PH | Power Headroom |
| PHY | Physical (layer) |
| PRACH | Physical Random Access Channel |
| PUCCH | Physical Uplink Control Channel |
| PUSCH | Physical Uplink Shared Channel |
| QCL | Quasi-colocation |
| RA | Random Access |
| RACH | Random Access Channel |
| RAN | Radio Access Network |
| Rel | Release |
| RF | Radio Frequency |
| RLF | Radio Link Failure |
| RNTI | Radio Network Temporary Identifier |
| RRC | Radio Resource Control |
| RS | Reference Signal |
| RSRP | Reference Signal Received Power |
| RSSI | Received Signal Strength Indicator |
| Rx | Reception |
| SCell | Secondary Cell |
| SCG | Secondary Cell Group |
| SDM | Spatial Division Multiplexing |
| SFN | Single-Frequency Network |
| SINR | Signal to Interference plus Noise Ratio |
| SN | Secondary Node |
| SSB | Synchronization Signal Block |
| sTRP | Single-TRP |
| TA | Timing Advance |
| TAG | Timing Advance Group |
| TB | Transport Block |
| TCI | Transmission Configuration Indicator |
| TRP | Transmission Reception Point |
| TS | Technical Specification |
| Tx | Transmission |
| UE | User Equipment |
| UL | Uplink |
| URLLC | Ultra-Reliable and Low-Latency Communication |

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not illustrated) by the same numerals in the drawings. However, the features in different implementations may be different in other respects and may not be narrowly confined to what is illustrated in the drawings.

References to “one implementation,” “an implementation,” “example implementation,” “various implementations,” “some implementations,” “implementations of the present application,” etc., may indicate that the implementation(s) of the present application so described may include a particular feature, structure, or characteristic, but not every possible implementation of the present application necessarily includes the particular feature, structure, or characteristic. Further, repeated use of the phrase “In some implementations,” or “in an example implementation,” “an implementation,” do not necessarily refer to the same implementation, although they may. Moreover, any use of phrases like “implementations” in connection with “the present application” are never meant to characterize that all implementations of the present application must include the particular feature, structure, or characteristic, and should instead be understood to mean “at least some implementations of the present application” includes the stated particular feature, structure, or characteristic. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent.

The expression “at least one of A, B and C” or “at least one of the following: A, B and C” means “only A, or only B, or only C, or any combination of A, B and C.” The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

For the purposes of explanation and non-limitation, specific details, such as functional entities, techniques, protocols, and standards, are set forth for providing an understanding of the disclosed technology. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software, or a combination of software and hardware. Disclosed functions may correspond to modules which may be software, hardware, firmware, or any combination thereof.

A software implementation may include computer executable instructions stored on a computer-readable medium, such as memory or other type of storage devices. One or more microprocessors or general-purpose computers with communication processing capability may be programmed with corresponding executable instructions and perform the disclosed network function(s) or algorithm(s).

The microprocessors or general-purpose computers may include Application-Specific Integrated Circuits (ASICs), programmable logic arrays, and/or one or more Digital Signal Processor (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture such as a Long-Term Evolution (LTE) system, an LTE-Advanced (LTE-A) system, an LTE-Advanced Pro system, or a 5G NR Radio Access Network (RAN) typically includes at least one base station (BS), at least one UE, and one or more optional network elements that provide connection within a network. The UE communicates with the network such as a Core Network (CN), an Evolved Packet Core (EPC) network, an Evolved Universal Terrestrial RAN (E-UTRAN), a 5G Core (5GC), or an internet via a RAN established by one or more BSs.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a RAN.

The BS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include, but is not limited to, a node B (NB) in the UMTS, an evolved node B (eNB) in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. The BS may serve one or more UEs via a radio interface.

The BS may be operable to provide radio coverage to a specific geographical area using multiple cells forming the RAN. The BS supports the operations of the cells. Each cell is operable to provide services to at least one UE within its radio coverage.

Each cell (may often referred to as a serving cell) may provide services to one or more UEs within the cell's radio coverage, such that each cell schedules the DL and optionally UL resources to at least one UE within its radio coverage for DL and optionally UL packet transmissions. The BS may communicate with one or more UEs in the radio communication system via the of cells.

A cell may allocate sidelink (SL) resources for supporting Proximity Services (ProSe) or Vehicle to Everything (V2X) services. Each cell may have overlapped coverage areas with other cells.

In Multi-RAT Dual Connectivity (MR-DC) cases, the primary cell of a Master Cell Group (MCG) or a Secondary Cell Group (SCG) may be called a Special Cell (SpCell). A Primary Cell (PCell) may include the SpCell of an MCG. A Primary SCG Cell (PSCell) may include the SpCell of an SCG. MCG may include a group of serving cells associated with the Master Node (MN), including the SpCell and optionally one or more Secondary Cells (SCells). An SCG may include a group of serving cells associated with the Secondary Node (SN), including the SpCell and optionally one or more SCells.

As discussed above, the frame structure for NR supports flexible configurations for accommodating various next generation (e.g., 5G) communication requirements, such as Enhanced Mobile Broadband (eMBB), Massive Machine Type Communication (mMTC), and Ultra-Reliable and Low-Latency Communication (URLLC), while fulfilling high reliability, high data rate, and low latency requirements. The Orthogonal Frequency-Division Multiplexing (OFDM) technology in the 3GPP may serve as a baseline for an NR waveform. The scalable OFDM numerology, such as adaptive sub-carrier spacing, channel bandwidth, and Cyclic Prefix (CP), may also be used.

Two coding schemes are considered for NR, specifically, Low-Density Parity-Check (LDPC) code and Polar Code. The coding scheme adaption may be configured based on channel conditions and/or service applications.

At least DL transmission data, a guard period, and a UL transmission data should be included in a transmission time interval (TTI) of a single NR frame. The respective portions of the DL transmission data, the guard period, and the UL transmission data should also be configurable based on, for example, the network dynamics of NR. SL resources may also be provided in an NR frame to support ProSe services or V2X services.

Any two or more than two of the following paragraphs, (sub)-bullets, points, actions, behaviors, terms, or claims described in the present disclosure may be combined logically, reasonably, and properly to form a specific method.

Any sentence, paragraph, (sub)-bullet, point, action, behaviors, terms, or claims described in the present disclosure may be implemented independently and separately to form a specific method.

Dependency, e.g., “based on”, “more specifically”, “preferably”, “in one embodiment”, “in some implementations”, etc., in the present disclosure is just one possible example which would not restrict the specific method.

“A and/or B” in the present disclosure may include either A or B, both A and B, at least one of A and B.

Examples of some selected terms in the present disclosure are provided as follows.

Antenna Panel: an antenna panel is a conceptual term for UE antenna implementation. It may be assumed that a panel is an operational unit for controlling a transmission spatial filter (e.g., a beam). A panel may include multiple antenna elements. A beam may be formed by a panel, and two panels may be needed to form two beams simultaneously. Such simultaneous beamforming from multiple panels may be subject to UE capability. A similar definition for “antenna panel” may be possible by applying spatial receiving filtering characteristics.

Beam: the terms “beam” and “spatial filter” may be used interchangeably in the present disclosure. For example, when a UE reports a preferred gNB Tx beam, the UE is essentially selecting a spatial filter used by the gNB. The term “beam information” is used to provide information about which beam/spatial filter is being used/selected. In some implementations, individual reference signals are transmitted by applying individual beams (spatial filters). Thus, the term “beam” or “beam information” may be represented by reference signal resource index(es).

DCI: DCI stands for downlink control information and there are various DCI formats used in the PDCCH. The DCI format is a predefined format in which the downlink control information is packed/formed and transmitted in the PDCCH.

TCI state: a TCI state contains parameters for configuring a QCL relationship between one or two reference signals and a target reference signal set. For example, a target reference signal set may be the DM-RS ports of the PDSCH, PDCCH, PUCCH or PUSCH.

HARQ: HARQ is a functionality that ensures delivery between peer entities at Layer 1 (e.g., PHY Layer). A single HARQ process may support one TB when the PHY layer is not configured for DL/UL spatial multiplexing. A single HARQ process may support one or multiple TBs when the PHY layer is configured for DL/UL spatial multiplexing. There may be one HARQ entity per serving cell. Each HARQ entity may support parallel processing of (e.g., multiple) DL and UL HARQ processes.

Unlike legacy handovers (e.g., L3 HO, CHO, DAPS), in an LTM procedure the handovers may be performed via L1/L2 signaling. An LTM procedure may be able to reduce the latency in an HO procedure effectively. However, before, during, or after a UE switches from a source cell to a selected candidate target cell, the UE may need to be indicated a beam to receive DL signals from the selected candidate target cell and/or to transmit UL signals to the selected candidate target cell. The present disclosure describes, among other things, a beam indication method corresponding to an LTM procedure for an HO. It should be noted that the selected candidate target cell (or the target cell) may be a candidate target cell indicated to the UE by a base station (e.g., a gNB) for cell switching.

The terms “an antenna port” and “antenna ports” described in this disclosure may refer to “an antenna port used for transmission of PUSCH(s)/PUCCH(s)” and “antenna ports used for transmission of PUSCH(s)/PUCCH(s),” respectively.

The term “A is QCLed with B” may mean that the A shares the same channel characteristic(s)/QCL assumption with B. The type of channel characteristic(s)/QCL assumption may include the following types:
‘typeA’: {Doppler shift, Doppler spread, average delay, delay spread}
‘typeB’: {Doppler shift, Doppler spread}
‘typeC’: {Doppler shift, Doppler spread}
‘typeD’: {Spatial Rx parameter}

The source cell/gNB may configure one or more candidate target cells to the UE for performing the LTM procedure. Each candidate target cell may be identified by a PCI value and/or a logical value (e.g., an additional PCI index). For example, if the UE is configured with seven candidate target cells by the source cell/gNB, these candidate target cells may be identified by the values PCI #1, PCI #2, . . . , and PCI #7.

### Beam Indication for LTM

During the LTM procedure, the UE may be indicated the beam information/configuration corresponding to the (selected) candidate target cell(s) via RRC signaling, MAC CE, and/or DCI. In addition, the beam information/configuration corresponding to the (selected) candidate target cell(s) may be indicated by the source gNB/cell and/or the (selected) candidate target cell. The beam information/configuration corresponding to the (selected) candidate target cell(s) may be indicated to the UE before, during, and/or after receiving a cell switch command. The cell switch command may correspond to the UE receiving an LTM cell switch command indicating a target cell. In some implementations, the beam information/configuration (e.g., a TCI state) corresponding to the target cell may be indicated to the UE by the source cell before the UE receives the LTM cell switch command.

### RRC Pre-Configuration

In an RRC pre-configuration procedure, the UE may be configured with the information/configuration associated with the candidate target cells from the source cell/gNB via RRC signaling (e.g., an RRCReconfiguration message). The information/configuration may include the configuration corresponding to the beam/cell measurement (e.g., RS(s)/SSB(s) used for beam/cell measurement, TCI state used for receiving the RS(s) used for measurement), the configuration corresponding to the DL synchronization (e.g., SSB(s) configuration corresponding to each candidate target cell, DL TCI state(s) used for receiving DL signal(s)/channel(s) corresponding to one or more candidate target cell(s), UL TCI state(s) used for transmitting UL signal(s)/channel(s) corresponding to one or more candidate cell(s), and/or joint TCI state(s) used for receiving DL signal(s)/channel(s) and transmitting UL signal(s)/channel(s) corresponding to one or more candidate cell(s)), and the configuration corresponding to the UL synchronization (e.g., a RACH configuration corresponding to each candidate target cell, an indicator that indicates whether to perform an RA procedure in the candidate target cell).

In order to indicate the beam information/configuration corresponding to the (selected) candidate target cell(s) to the UE, the source cell/gNB may configure one or more lists of beam information/configuration (e.g., TCI states) corresponding to the candidate target cells in an RRC (pre-)configuration corresponding to a candidate target cell and/or a common RRC (pre-)configuration. In some implementations, the source cell may provide an RRC (pre-)configuration for each candidate target cell. Each candidate target cell may correspond to an RRC (pre-)configuration that includes a TCI state configuration. The TCI states may be a UL TCI state, a DL TCI state, and/or a joint TCI state. In some implementations, the RRC (pre-)configuration may include a parameter for indicating a separate TCI mode (e.g., corresponding to the UL TCI state and the DL TCI state) or a joint TCI mode.

The UL TCI state may be used to indicate to the UE the transmission beam for a UL transmission. The DL TCI state may be used to indicate to the UE the reception beam for a DL reception. The joint TCI state may be used to indicate to the UE the common beam for a UL transmission and a DL reception. In some implementations, the common RRC (pre-)configuration may include the configurations (e.g., configuration(s) of TCI state(s) and/or configurations of SSB(s)) corresponding to each candidate target cell. The common RRC (pre-)configuration may be an RRC message (e.g., the RRCReconfiguration message) or a configuration/IE in the RRC message (e.g., the RRCReconfiguration message).

In some implementations, the configuration/IE may be an LTM candidate cell configuration corresponding to a candidate cell. The one or more lists of beam information/configuration may correspond to the candidate target cell indicated by the LTM candidate cell configuration. In some implementations, the configuration/IE may be a serving cell configuration of the UE's current serving cell. The one or more lists of beam information/configuration may correspond to the UE's current serving cell. In some implementations, the configuration/IE may be a reference signal (RS) location configuration for an SSB measurement of a candidate cell. The one or more list of beam information/configuration may correspond to the candidate cell or correspond to the RS measurement of the candidate cell. In some implementations, the configuration/IE may be a location configuration of a TCI state for a candidate cell. The one or more lists of beam information/configuration may correspond to the candidate cell's TCI state.

In some implementations, a UE may be configured with one or more common RRC (pre-)configuration(s) by the source cell/gNB via RRC signaling (e.g., the RRCReconfiguration message).

One of the one or more common RRC (pre-)configuration(s) may be the SSB configuration(s) associated with different candidate target cell(s). In some implementations, the UE may be configured with one list of SSB configuration(s) via RRC signaling by the source cell/gNB. In some implementations, the UE may be configured with one or more SSB configuration(s) via RRC signaling by the source cell/gNB, and the one or more SSB configurations may include a PCI value or a logical index (e.g., the additionalPCI index or the index of the candidate target cell).

In some implementations, the UE may be configured with one list of SSB configurations via RRC signaling by the source cell/gNB. The list of SSB configurations may be an RRC list (e.g., a SEQUENCE list), where each SSB configuration corresponding to candidate target cells may be associated with an entry of the RRC list. Each SSB configuration may include the information indicating the SSB resources on which the UE performs the measurement.

In some implementations, the number of SSB configurations (e.g., in the RRC list) may be equal to the number of candidate target cells configured to the UE by the source cell/gNB. In some implementations, the order of each SSB configuration in the RRC list may be associated with the order of candidate target cells configured to the UE by the source cell/gNB.

The UE may be configured with one RRC list of SSB configurations by the source cell/gNB. In addition, the UE may be configured with one or more candidate target cells by the source cell/gNB. The N^{th} SSB configuration in the RRC list may be associated with the N^{th} candidate target cell (e.g., the candidate target cell with the N^{th} lowest PCI value or the candidate target cell with the N^{th} lowest additionalPCIIndex value). For example, the first SSB configuration in the RRC list may be associated with the candidate target cell that has the lowest PCI value or the additionalPCIIndex equal to 1.

The UE may be configured with one RRC list of SSB configurations by the source cell/gNB. In addition, the UE may be configured with one or more candidate target cells by the source cell/gNB. The UE may be further configured with one list of PCI values corresponding to the configured candidate target cells via RRC signaling by the source cell/gNB. The N^{th} SSB configuration in the RRC list may be associated with the N^{th} PCI value in the PCI list. For example, the N^{th} SSB configuration may include the information indicating the SSB resources on which the UE performs the measurement and the SSB resources may be associated with the cell indicated by the N^{th} PCI value.

In some implementations, the number of SSB configurations (e.g., in the RRC list) may be larger than the number of candidate target cells configured to the UE by the source cell/gNB.

Each SSB configuration (e.g., in the RRC list) may include a PCI value or a logical index (e.g., the additionalPCIindex or the index of a candidate target cell). In some implementations, if the field corresponding to the PCI value in the SSB configuration (e.g., in the RRC list) is absent, the SSB configuration may be associated with the source cell or the serving cell.

In some implementations, the order of SSB configurations in the RRC list may be associated with the order of candidate target cells configured to the UE by the source cell/gNB.

In some implementations, more than one SSB configurations may be associated with the same PCI value or the same logical index.

The UE may be configured with one RRC list of SSB configurations by the source cell/gNB. In addition, the UE may be configured with one or more candidate target cells by the source cell/gNB. The first SSB configuration in the RRC list may be associated with the source cell and/or the serving cell. The other SSB configurations (e.g., the second SSB configuration to the last SSB configuration) in the RRC list may be associated with the candidate target cells. The candidate target cells here may mean the cell(s) with the PCI value different from the PCI of the serving cell. In addition, the (N+1)^{th} SSB configuration in the RRC list may be associated with the N^{th} candidate target cell (e.g., the candidate target cell with the N^{th} lowest PCI value or the candidate target cell with the N^{th} lowest additionalPCIIndex value). For example, the second SSB configuration in the RRC list may be association with the candidate target cell that has the lowest PCI value or the additionalPCIIndex equal to 1.

In some implementations, the number of SSB configurations (e.g., in the RRC list) may be less than the number of candidate target cells configured to the UE by the source cell/gNB.

Each SSB configuration (e.g., in the RRC list) may include a PCI value or a logical index (e.g., the additionalPCIindex or the index of a candidate target cell). In some implementations, if the field corresponding to the PCI value in the SSB configuration (e.g., in the RRC list) is absent, the SSB configuration may be associated with the source cell or serving cell.

In some implementations, more than one PCI values or logical indices may be associated with the same SSB configuration.

In some implementations, each SSB configuration (e.g., in the RRC list) may correspond to one or more PCI values or one or more logical indices (e.g., the additionalPCIindex or the index of a candidate target cell). Each of the one or more PCI values or the one or more logical indices may be included in a configuration/IE other than (or external to) the SSB configuration(s). For example, the configuration/IE other than (or external to) the SSB configuration(s) may be, but not limited to, an LTM candidate cell configuration corresponding to a candidate cell, a serving cell configuration of the UE's current serving cell, a location configuration of TCI state for a candidate cell.

In some implementations, one of the one or more common RRC (pre-)configurations may be the TCI state configuration(s) associated with the serving cell and/or the candidate target cell(s).

In some implementations, if the type/mode of the TCI state indicated by an RRC parameter is the ‘separate’ mode, the UE may be configured with one list of DL TCI state configuration(s) associated with the serving cell and/or different candidate target cell(s) and one list of UL TCI state configuration(s) associated with the serving cell and/or different candidate target cell(s) via RRC signaling by the source cell/gNB. The RRC parameter may be provided to the UE by the source cell/gNB.

In some implementations, if the type/mode of the TCI state indicated by an RRC parameter is the ‘separate’ mode, the UE may be configured with one or more lists of DL TCI state configuration(s) (and each list may be associated with one or more serving cell and/or candidate target cell(s)), and one or more lists of UL TCI state configuration(s) (and each list may be associated with one or more serving cell and/or candidate target cell(s)) via RRC signaling by the source cell/gNB. The RRC parameter may be provided to the UE by the source cell/gNB.

In some implementations, if the type/mode of the TCI state indicated by an RRC parameter is the ‘joint’ mode, the UE may be configured with one list of joint TCI state configuration(s) associated with the serving cell and/or different candidate target cell(s) via RRC signaling by the source cell/gNB. The RRC parameter may be provided to the UE by the source cell/gNB.

In some implementations, if the type/mode of the TCI state indicated by an RRC parameter is the ‘joint’ mode, the UE may be configured with one or more lists of joint TCI state configuration(s) (and each list may be associated with one or more serving cell and/or candidate target cell(s)) via RRC signaling by the source cell/gNB. The RRC parameter may be provided to the UE by the source cell/gNB.

In some implementations, one of the one or more common RRC (pre-)configuration(s) may include an RRC parameter that indicates the timing of the beam indication (e.g., before the cell switch command, in the cell switch command, or after the cell switch command). The RRC parameter may be received by the UE and transmitted by the source cell/gNB.

In some implementations, the RRC parameter may indicate to the UE to receive one or more beam indication(s) and/or TCI state(s) corresponding to the serving cell and/or one or more candidate target cell(s) before the cell switch command. The UE may expect to receive the beam indication via DCI, a MAC CE, and/or a dedicated RRC message (e.g., the RRCReconfiguration message) signaled by the source cell/gNB. The MAC CE may include, but not limited to, the information of the TCI state(s), the information of the PCI(s), the information of the serving cell index, the information of the additionalPCIIndex, and the information for indicating whether the TCI state(s) is for UL and/or DL. The MAC CE including the beam indication may be different from the cell switch command, which may be carried by another MAC CE.

In some implementations, the RRC parameter may indicate to the UE to receive one or more beam indication(s) and/or TCI state(s) corresponding to the serving cell and/or one or more candidate target cell(s) in the cell switch command. The cell switch command may include the information of the beam indication and/or TCI state(s), the information of the association between the information of the beam indication and/or TCI state(s) and the corresponding cell (e.g., the serving cell, one or more candidate target cell(s), the selected target cell). It should be noted that the cell switch command may be also referred to as the LTM cell switch command in the present disclosure.

In some implementations, the RRC parameter may indicate to the UE to receive one or more beam indication(s) and/or TCI state(s) corresponding to the target cell after receiving the cell switch command that indicates the target cell. For example, the RRC parameter may be set to ‘enable’ or ‘disable’. If the RRC parameter is set to ‘enable’, the field that indicates the TCI state(s)/beam(s) corresponding to the target cell may not be present in the cell switch command. After receiving the cell switch command, the UE may expect the target cell to indicate the TCI state(s)/beam(s). The TCI state(s)/beam(s) corresponding to the target cell may be indicated by the target cell via RRC signaling, MAC CE and/or DCI. If the RRC parameter is set to ‘disable’, the field that indicates the TCI state(s)/beam(s) corresponding to the target cell may be present in the cell switch command. The TCI state(s)/beam(s) corresponding to the target cell may be indicated in the cell switch command.

In some implementations, the RRC parameter that indicates the timing of the beam indication may be set to ‘enable’ or ‘disable’. Furthermore, the UE may report its capability to indicate whether the UE supports receiving the beam indication before the cell switch command. If the RRC parameter is set to ‘enable’, the UE may expect to receive the beam indication before the cell switch command. On the other hand, if the RRC parameter is set to ‘disable’ or the RRC parameter is absent, the UE may not expect to receive the beam indication before the cell switch command.

In some implementations, the RRC parameter that indicates the timing of the beam indication may be set to ‘enable’ or ‘disable’. Furthermore, the UE may report its capability to indicate whether the UE supports receiving the beam indication in the cell switch command. If the RRC parameter is set to ‘enable’, the UE may expect to receive the beam indication in the cell switch command. On the other hand, if the RRC parameter is set to ‘disable’ or the RRC parameter is absent, the UE may not expect to receive the beam indication in the cell switch command.

In some implementations, the RRC parameter that indicates the timing of the beam indication may be set to ‘enable’ or ‘disable’. Furthermore, the UE may report its capability to indicate whether the UE supports receiving the beam indication after the cell switch command. If the RRC parameter is set to ‘enable’, the UE may expect to receive the beam indication after the cell switch command. On the other hand, if the RRC parameter is set to ‘disable’ or the RRC parameter is absent, the UE may not expect to receive the beam indication after the cell switch command.

In some implementations, one of the one or more common RRC (pre-)configuration(s) may include an RRC parameter that indicates whether the TCI states (e.g., DL TCI states, UL TCI states, and/or joint TCI states) corresponding to a serving cell and/or candidate target cell(s) are activated before the UE receives the cell switch command. The RRC parameter may be received by the UE and transmitted by the source cell/gNB.

In some implementations, if the RRC parameter indicates to the UE that the TCI state(s) corresponding to the serving cell and/or the candidate target cell(s) are activated before the UE receives the cell switch command, the UE may receive an activation command of the TCI state(s) before the UE receives the cell switch command. The activation command of the TCI state(s) may be an MAC CE. The MAC CE for the activation command of the TCI state(s) may include multiple status indications (e.g., activate/deactivate), where the value ‘1’ may represent ‘activate’ and the value ‘0’ may represent ‘deactivate’, and multiple TCI state(s). Each status indication may correspond to one or more TCI state(s). It should be noted that the activation command of the TCI state(s) may also be referred to as the LTM TCI state activation command in the present disclosure.

In some implementations, if the RRC parameter indicates to the UE that the TCI state(s) corresponding to the serving cell and/or the candidate target cell(s) are not activated before the UE receives the cell switch command, the TCI field in the cell switch command may indicate the TCI state (e.g., DL TCI state, UL TCI state, and/or joint TCI state) corresponding to the target cell and activate the TCI state.

In some implementations, the RRC parameter that indicates whether the TCI states corresponding to the serving cell and/or the candidate target cell(s) are activated before the UE receives the cell switch command may be set to ‘enable’ or ‘disable’. If the RRC parameter is set to ‘enable’, the UE may expect to receive the activated TCI state(s) before the cell switch command. On the other hand, if the RRC parameter is set to ‘disable’ or is absent, the UE may expect to receive the activated TCI state(s) in the cell switch command.

### TCI State Activation

In some implementations, a UE may be indicated to receive an activation command of the TCI state(s) (e.g., DL TCI state(s), UL TCI state(s), and/or joint TCI state(s)) via DCI and/or a MAC-CE from the source cell/gNB before the UE receives the cell switch command.

In some implementations, the UE may receive an activation command for mapping one or more TCI state(s) or one or more pairs of TCI states to the codepoints of the field (e.g., the TCI field) in the cell switch command for the serving cell and/or one or multiple candidate target cell(s). A pair of TCI states may include a DL TCI state for DL signal(s)/channel(s) and a UL TCI state for UL signal(s)/channel(s).

In some implementations, the RRC (pre-)configuration may include an RRC parameter that indicates whether the UE receives the activation command, where the RRC parameter may be transmitted by the source cell/gNB.

In some implementations, a timer may be configured to the UE by the source cell/gNB for monitoring the DCI that schedules the cell switch command, where the value of the timer may be configured by the RRC signaling. The value of the timer may be the initial value or the maximum value of the timer. The UE may start the timer when the UE transmits, to the source cell/gNB, the HARQ-ACK information corresponding to the reception of the activation command of the TCI state(s) via a PUCCH or a PUSCH. If the UE does not detect the PDCCH that schedules the cell switch command before the timer expires, the UE may transmit a cell switch command request to the source cell/gNB to request the cell switch command. After the UE transmits the cell switch command request to the source cell/gNB, the UE may restart the timer.

In some implementations, in addition to, or instead of, the timer, the UE may be configured with a counter to count the number of times that the UE fails to receive the cell switch command. When the timer expires and the UE does not receive (or fails to receive) the cell switch command, the counter may be increased (e.g., added by 1). If the counter (e.g., the number of times that the UE fails to receive the cell switch command) becomes larger than a threshold value, the UE may declare an RLF. In some implementations, the threshold value may be configured to the UE by the source cell/gNB via RRC signaling (e.g., the RRCReconfiguration message, during the RRC pre-configuration procedure). In some implementations, the threshold value may be a pre-defined value. The cell switch command request may include a 1-bit indicator transmitted on a (pre-)configured PUCCH or PUSCH resource configured in the RRC (pre-)configuration.

In some implementations, a timing window may be configured to the UE by the source cell/gNB for monitoring the DCI that schedules the cell switch command, where the (maximum) value of the timing window may be configured by the RRC signaling (e.g., the RRCReconfiguration message, during the RRC pre-configuration procedure) or a pre-defined value. When the UE transmits, to the source cell/gNB, the HARQ-ACK information corresponding to reception of the activation command of the TCI state(s) via a PUCCH or a PUSCH, the UE may start monitoring the DCI that schedules the cell switch command. If the UE does not detect the PDCCH that schedules the cell switch command in the configured or pre-defined timing window, the UE may transmit a cell switch command request to the source cell/gNB to request for the cell switch command.

In some implementations, in addition to, or instead of, the timing window, the UE may be configured with a counter to count the number of times that the UE fails to receive the cell switch command. If the number of times that the UE fails to receive the cell switch command is larger than a threshold value, the UE may declare an RLF. In some implementations, the threshold value may be configured to the UE by the source cell/gNB via RRC signaling (e.g., the RRCReconfiguration message, during the RRC pre-configuration procedure). In some implementations, the threshold value may be a pre-defined value.

### Cell Switch Command

In a cell switch command procedure, the UE may receive a MAC CE including the information/configuration corresponding to the target cell. The MAC CE may be transmitted by the source cell/gNB. The MAC CE may include at least one of the following fields:
Cell ID: This field may indicate the identity of the candidate target cell to which the MAC CE applies. For example, this field corresponds to the target cell indicated by the cell switch command for the LTM operation. In some implementations, the value indicated in this field may be a PCI value or a logical value (e.g., the additionalPCIIndex).
CC group: This field may indicate a set of candidate target cells.
BWP ID: This field may indicate the BWP of the candidate target cell to which the MAC-CE applies.
TCI state ID: This field may indicate an identifier of the TCI state used for the (selected) candidate target cell. This field may indicate one of the following combinations of TCI states: a DL TCI state, a UL TCI state, a DL TCI state and a UL TCI state, a joint TCI state, two DL TCI states, two UL TCI states, two DL TCI states and two UL TCI states, and two joint TCI states.
TAG ID: This field may indicate the TAG identity of the addressed TAG.
Timing Advanced Command: This field may indicate the index value TA used to control the amount of timing adjustment that the MAC entity may apply.
D/U: This field may indicate whether the TCI state ID in the same octet is for joint/downlink or uplink TCI state. If this field is set to 1, the TCI state ID in the same octet may be for joint/downlink. If this field is set to 0, the TCI state ID in the same octet may be for uplink.
CORESETPoolindex: This field may indicate whether the indicated DL reception or UL transmission is associated with the same TRP.
Applied mTRP scheme: a codepoint may indicate ‘SDM’, ‘SFN’, ‘CJT’ scheme, respectively.
Pi: This field may indicate whether each TCI codepoint has multiple TCI states or single TCI state. If the Pi field is set to 1, it may indicate that the i^{th} TCI codepoint includes the DL TCI state and the UL TCI state. If the Pi field is set to 0, it may indicate that the i^{th} TCI codepoint includes only the DL/joint TCI state or the UL TCI state. The codepoint to which a TCI state is mapped may be determined by its ordinal position among all the TCI state ID fields. In some implementations, if the Pi field is set to 1, it may indicate that the i^{th} TCI codepoint includes more than one DL/UL TCI state pairs (e.g., for mTRP indication). If the Pi field is set to 0, it may indicate that the i^{th} TCI codepoint includes only single DL/joint TCI state or the UL TCI state (e.g., for sTRP indication).
R: It may be a reserved bit, set to 0.

In some implementations, if the TCI state corresponding to the target cell (or the TCI state indicated in the TCI field in the cell switch command) is not activated in the activation command of the TCI states (e.g., the LTM TCI state activation command), the TCI field in the cell switch command may be used to activate and indicate the TCI state (e.g., the DL TCI state, the UL TCI state, and/or the joint TCI state) corresponding to the target cell. For example, the TCI field in the cell switch command may indicate the TCI state corresponding to the target cell and activate the TCI state.

In some implementations, the number of activated TCI states in the cell switch command may be one (or one pair) for the sTRP operation or two (or two pairs) for the mTRP operation.

In some implementations, if the UE is configured to receive the beam indication after the cell switch command, the TCI field in the cell switch command may be absent.

In some implementations, if the target cell indicated in the cell switch command is an inter-DU based candidate target cell, the TCI field in the cell switch command may be absent.

### Time to Apply the Beam Indicated in the Cell Switch Command

In some implementations, the UE may be configured with two timing values (e.g., beamApp Time1 and beamAppTime2) by the source cell/gNB via RRC signaling. The second configured timing value (e.g., the beamAppTime2) may be larger than the first configured timing value (e.g., the beamAppTime 1). In some implementations, the UE may apply the beam/TCI state indicated (and activated) by the cell switch command (e.g., carried in an MAC CE) for the DL reception and/or the UL transmission corresponding to the target cell starting from the first slot that is at least M symbols after the last symbol of the PUCCH or the PUSCH used to transmit the HARQ-ACK information related to the cell switch command reception. M may be equal to the second configured timing value (e.g., the beamAppTime2). The related implementations may include:
The UE may report that it is capable of being indicated the beam activation and indication corresponding to the target cell in the same MAC CE/cell switch command transmitted by the source cell/gNB. In other words, the UE may report that it is capable of activating and preparing to apply the beam for the corresponding DL and/or UL operation related to the target cell according to a MAC CE/cell switch command transmitted by the source cell/gNB.
The UE may receive an RRC parameter that informs the UE that the cell switch command is used to indicate the beam/TCI state corresponding to the target cell and activate the beam/TCI state. The RRC parameter may be included in a common LTM pre-configuration (e.g., an RRC pre-configuration including the information related to each candidate target cell and/or serving cell) or an LTM pre-configuration (e.g., an RRC pre-configuration including the information related to a specific candidate target cell).
The UE may receive an RRC parameter that indicates to the UE that the UE may not receive an activation command of the TCI states before receiving the cell switch command. The RRC parameter may be included in a common LTM pre-configuration (e.g., an RRC pre-configuration including the information related to each candidate target cell and/or serving cell) or an LTM pre-configuration (e.g., an RRC pre-configuration including the information related to a specific candidate target cell). The RRC parameter may be in an ENUMERATED format (e.g., ENUMERATED {‘before’}). If the value of the RRC parameter is set, it may indicate that the UE may receive (or may expect to receive) the activation command of the TCI states before receiving the cell switch command. If the value of the RRC parameter is absent, it may indicate that the UE may not receive (or may not expect to receive) the activation command of the TCI states before receiving the cell switch command.
The UE does not receive the activation command of the TCI states before receiving the cell switch command.

In some implementations, the UE may apply the beam/TCI state indicated in the cell switch command for the DL reception and/or UL transmission corresponding to the target cell starting from the first slot that is at least M symbols after the last symbol of the PUCCH or the PUSCH used to transmit the HARQ-ACK information related to the cell switch command reception. M may be equal to the first configured timing value (e.g., the beamApp Time1). The related implementations may include:
The UE may report that it is capable of being indicated the beam activation and indication corresponding to the target cell in the same MAC CE/cell switch command transmitted by the source cell/gNB. In other words, the UE may report that it is capable of activating and preparing to apply the beam for the corresponding DL and/or UL operation related to the target cell according to one MAC CE/cell switch command transmitted by the source cell/gNB.
The UE may receive an RRC parameter that informs the UE that the cell switch command is (only) used to indicate the beam/TCI state corresponding to the target cell. The RRC parameter may be included in a common LTM pre-configuration (e.g., an RRC pre-configuration comprising the information related to each candidate target cell and/or serving cell) or an LTM pre-configuration (e.g., an RRC pre-configuration including the information related to a specific candidate target cell). The RRC parameter may be in an ENUMERATED format (e.g., ENUMERATED {‘beam/TCI state’}). If the value of the RRC parameter is set, it may indicate that the UE may receive (or expect to receive) only the beam/TCI state corresponding to the target cell in the cell switch command. If the value of the RRC parameter is absent, it may indicate that the UE may not receive (or not expect to receive) the cell switch command including only the beam/TCI state corresponding to the target cell. For example, the UE may receive the cell switch command including information other than the beam/TCI state corresponding to the target cell.
The UE may receive an RRC parameter that indicates the UE that the UE may receive an activation command of the TCI states before receiving the cell switch command. The RRC parameter may be included in a common LTM pre-configuration (e.g., an RRC pre-configuration including the information related to each candidate target cell and/or serving cell) or an LTM pre-configuration (e.g., an RRC pre-configuration including the information related to a specific candidate target cell). The RRC parameter may be in an ENUMERATED format (e.g., ENUMERATED {‘before’}). If the value of the RRC parameter is set, it may indicate that the UE may receive (or expect to receive) the activation command of the TCI states before receiving the cell switch command. If the value of the RRC parameter is absent, it may indicate that the UE may not receive (or not expect to receive) the activation command of the TCI states before receiving the cell switch command.
The UE may receive the activation command of the TCI states before receiving the cell switch command.

In some implementations, the UE may be configured with the first timing value (e.g., the beamApp Time1) or the second timing value (e.g., the beamApp Time2) by the source cell/gNB via RRC signaling. The second configured timing value (e.g., the beamApp Time2) may be larger than the first configured timing value (e.g., the beamAppTime1). In some implementations, the UE may receive the second configured timing value (e.g., the beamApp Time2) in the RRC pre-configuration from the source cell/gNB. The UE may apply the beam/TCI state indicated (and activated) in the cell switch command for the DL reception and/or UL transmission corresponding to the target cell starting from the first slot that is at least the second configured timing value (e.g., the beamApp Time2) symbols after the last symbol of the PUCCH or the PUSCH used to transmit the HARQ-ACK information related to the cell switch command reception. The related implementations may include:
The UE may report that it is capable of being indicated the beam activation and indication corresponding to the target cell in the same MAC CE/cell switch command transmitted by the source cell/gNB. In other words, the UE may report that it is capable of activating and preparing to apply the beam for the corresponding DL and/or UL operation related to the target cell according to one MAC CE/cell switch command transmitted by the source cell/gNB.
The UE may receive an RRC parameter that informs the UE that the cell switch command is used to indicate the beam/TCI state corresponding to the target cell and activate the beam/TCI state. The RRC parameter may be included in a common LTM pre-configuration (e.g., an RRC pre-configuration including the information related to each candidate target cell and/or serving cell) or an LTM pre-configuration (e.g., an RRC pre-configuration including the information related to a specific candidate target cell). The RRC parameter may be in an ENUMERATED format (e.g., ENUMERATED {‘beam/TCI state’}). If the value of the RRC parameter is set, it may indicate to the UE that the cell switch command is used to activate and/or indicate the beam/TCI state corresponding to the target cell. If the value of the RRC parameter is absent, it may indicate to the UE that the cell switch command is used for purposes other than to activate and/or indicate the beam/TCI state corresponding to the target cell.
The UE may receive an RRC parameter that indicates to the UE that the UE may not receive an activation command of the TCI states before receiving the cell switch command. The RRC parameter may be included in a common LTM pre-configuration (e.g., an RRC pre-configuration including the information related to each candidate target cell and/or serving cell) or an LTM pre-configuration (e.g., an RRC pre-configuration including the information related to a specific candidate target cell). The RRC parameter may be in an ENUMERATED format (e.g., ENUMERATED {‘before’}). If the value of the RRC parameter is set, it may indicate that the UE may receive (or expect to receive) the activation command of the TCI states before receiving the cell switch command. If the value of the RRC parameter is absent, it may indicate that the UE may not receive (or not expect to receive) the activation command of the TCI states before receiving the cell switch command.
The UE may not receive the activation command of the TCI states before receiving the cell switch command.

In some implementations, the UE may receive the first configured timing value (e.g., the beamApp Time1) in the RRC pre-configuration from the source cell/gNB. The UE may apply the beam/TCI state indicated in the cell switch command for the DL reception and/or UL transmission corresponding to the target cell starting from the first slot that is at least the first configured timing value (e.g., the beamApp Time1) symbols after the last symbol of the PUCCH or the PUSCH used to transmit the HARQ-ACK information related to the cell switch command reception. The related implementations may include:
The UE may report to the serving cell/gNB that the UE cannot support the beam activation and indication in the same MAC CE/cell switch command. For example, the UE may transmit a UECapabilityInformation message to report to the serving cell/gNB.
The UE may receive an RRC parameter that informs the UE that the cell switch command is (only) used to indicate the beam/TCI state corresponding to the target cell. The RRC parameter may be included in a common LTM pre-configuration (e.g., an RRC pre-configuration comprising the information related to each candidate target cell and/or serving cell) or an LTM pre-configuration (e.g., an RRC pre-configuration including the information related to a specific candidate target cell). The RRC parameter may be in an ENUMERATED format (e.g., ENUMERATED {‘beam/TCI state’}). If the value of the RRC parameter is set, it may indicate that the UE may receive (or expect to receive) only the beam/TCI state corresponding to the target cell in the cell switch command. If the value of the RRC parameter is absent, it may indicate that the UE may not receive (or not expect to receive) the cell switch command including only the beam/TCI state corresponding to the target cell. For example, the UE may receive the cell switch command including information other than the beam/TCI state corresponding to the target cell.
The UE may receive an RRC parameter that indicates to the UE that the UE may receive an activation command of the TCI states before receiving the cell switch command. The RRC parameter may be included in a common LTM pre-configuration (e.g., an RRC pre-configuration including the information related to each candidate target cell and/or serving cell) or an LTM pre-configuration (e.g., an RRC pre-configuration including the information related to a specific candidate target cell). The RRC parameter may be in an ENUMERATED format (e.g., ENUMERATED {‘before’}). If the value of the RRC parameter is set, it may indicate that the UE may receive (or expect to receive) the activation command of the TCI states before receiving the cell switch command. If the value of the RRC parameter is absent, it may indicate that the UE may not receive (or not expect to receive) the activation command of the TCI states before receiving the cell switch command.
The UE may receive the activation command of the TCI states before receiving the cell switch command.

In some implementations, the UE may be configured with two timing values (e.g., the beamApp Time1 and the beamApp Time2) via two RRC parameters for indicating the timing for applying the beam indicated in the cell switch command. In a case that the beam indicated in the cell switch command has been activated by the activation command of the TCI state received by the UE before the UE receives the cell switch command, the first timing value (e.g., the beamAppTime1) may be the time value configured to the UE for applying the beam indicated in the cell switch command. In a case that the beam indicated in the cell switch command is not activated before the UE receives the cell switch command, the second timing value (e.g., the beamAppTime2) may be the time value configured to the UE for applying the beam indicated in the cell switch command. In other words, if the UE receives the cell switch command that activates and indicates the TCI state (e.g., the DL TCI state, the UL TCI state, and/or the joint TCI state), the second timing value (e.g., the beamApp Time2) may be the time value configured to the UE for applying the beam indicated in the cell switch command. The second timing value may be larger than the first timing value. The unit of the timing values (e.g., the beamApp Time1 or the beamApp Time2) may be a symbol, a slot, a subframe, a frame, or a millisecond.

In some implementations, the UE may transmit a PUCCH with HARQ-ACK information or a PUSCH with HARQ-ACK information corresponding to the cell switch command. If the TCI state indicated in the cell switch command is not activated before the UE receives the cell switch command, the indicated TCI state (e.g., the DL TCI state, the UL TCI state, and/or the joint TCI state) may be applied starting from the first slot that is at least the second timing value (e.g., the beamApp Time2) symbols after the last symbol of the PUCCH or the PUSCH. If the TCI state indicated in the cell switch command has been activated before the UE receives the cell switch command, the indicated TCI state may be applied starting from the first slot that is at least the first timing value (e.g., the beamAppTime1) symbols after the last symbol of the PUCCH or the PUSCH.

In some implementations, if the beam indication is received before the cell switch command, the beam application time may be applied starting from the first slot when the UE receives the beam indication to ensure that the timing for receiving the cell switch command is after the beam application time starting from the last symbol of the beam indication.

In some implementations, the UE may be configured with a timing value (e.g., the beamApp Time) via an RRC parameter for indicating the timing for applying the beam indicated in the cell switch command. In a case that the beam indicated in the cell switch command is not activated before the UE receives the cell switch command, in addition to, or instead of, the timing value (e.g., the beamAppTime), the UE may be configured with one timing offset via RRC signaling or MAC CE (or the cell switch command) by the source cell/gNB. The unit of the timing offset may be a symbol, a slot, a subframe, a frame, or a millisecond.

In some implementations, the UE may transmit a PUCCH with HARQ-ACK information or a PUSCH with HARQ-ACK information corresponding to the cell switch command. If the TCI state indicated in the cell switch command is not activated before the UE receives the cell switch command, the indicated TCI state (e.g., the DL TCI state, the UL TCI state, and/or the joint TCI state) may be applied starting from the first slot that is at least the beamApp Time plus the timing offset symbols after the last symbol of the PUCCH or the PUSCH.

In some implementations, the timing offset may be reported by a UE capability.

In some implementations, the timing offset may be configured per cell. The timing offset may be associated with a PCI value.

In some implementations, the timing offset may be configured per TCI configuration for the LTM.

### Fast Recovery

For the LTM, one or multiple beam(s)/TCI state(s) may be indicated to a UE by the source cell/gNB before, during, and/or after the UE receives the cell switch command. In some implementations, when to receive the beam indication may be configured to the UE via RRC signaling, MAC CE, and/or DCI. The one or multiple beam(s)/TCI state(s) may be associated with the serving cell, the candidate target cell(s), and/or the target cell (e.g., the selected candidate target cell).

In some implementations, the UE may be indicated the TCI state corresponding to the target cell in the cell switch command. If the UE detects a beam failure corresponding to the beam associated with the TCI state indicated in the cell switch command, the UE may transmit the PRACH to the source cell/gNB in the configured RACH resource according to an SSB configuration of the source cell/gNB. In other words, the UE may trigger a random access procedure to the source cell/gNB. The SSB configuration corresponding to the source cell may be acquired by the previous/stored pre-configuration transmitted by the source cell to the UE before the cell switch command. The RACH resource may be a contention-free random access resource configured in the RRC configuration, a DCI format, and/or the cell switch command.

In some implementations, the UE may be indicated the TCI state corresponding to the target cell in the cell switch command. If the UE detects a beam failure corresponding to the beam associated with the TCI state indicated in the cell switch command, the UE may transmit the PRACH to the target cell in the configured RACH resource according to an SSB configuration of the target cell. The SSB configuration corresponding to the target cell may be acquired by the previous/stored pre-configuration transmitted by the source cell to the UE before the cell switch command. The RACH resource may be a contention-free random access resource configured in the RRC (pre-)configuration, an RRC configuration, a DCI format, and/or the cell switch command.

In some implementations, the UE may be configured with a threshold value by the source cell/gNB to evaluate the beam quality for determining a beam failure. The threshold value may be indicated by an RRC parameter/IE/field in the RRC (pre-)configuration (e.g., in the RRCReconfiguration message) or a field in the cell switch command. The threshold value may be the RSRP, RSSI, and/or SINR. If the quality of the source RS corresponding to the TCI state indicated in the cell switch command is less than the threshold value, the UE may determine a beam failure.

In some implementations, the UE may be configured with a threshold value by the source cell/gNB to evaluate the beam quality for determining a beam failure. In some implementations, the threshold value may be determined by the target cell and transmitted by the target cell to the source cell/gNB. In some implementations, the threshold value may be determined by the source cell/gNB. The threshold value may be indicated by an RRC parameter/IE/field in the RRC (pre-)configuration (e.g., in the RRCReconfiguration message) or a field in the cell switch command. The threshold value may be the RSRP, RSSI and/or SINR. If the quality of the target RS corresponding to the TCI state indicated in the cell switch command is less than the threshold value, the UE may determine a beam failure.

In some implementations, the UE may be indicated the TCI state corresponding to the target cell in the cell switch command. If the UE detects a beam failure corresponding to the beam associated with the TCI state indicated in the cell switch command, the UE may transmit the PRACH to the target cell or source cell in the configured RACH resource according to the beam used to receive the DCI (or PDCCH) scheduling the cell switch command. The SSB configuration or TCI state associated with the beam used to receive the DCI (or PDCCH) scheduling the cell switch command may be configured to the UE in the RRC (pre-)configuration (e.g., in the RRCReconfiguration message), a MAC CE (e.g., the TCI state activation command), the current cell switch command, and/or the previous cell switch command. The RACH resource may be a contention-free random access resource configured in the RRC (pre-)configuration (e.g., in the RRCReconfiguration message), an RRC configuration, a DCI format, and/or the cell switch command.

In some implementations, the UE may be configured with a threshold value by the source cell/gNB to evaluate the beam quality for determining a beam failure. The threshold may be indicated by an RRC parameter/IE/field in the RRC (pre-)configuration or a field in the cell switch command. The threshold value may be the RSRP, RSSI and/or SINR. If the quality of the source RS corresponding to the TCI state indicated in the cell switch command is less than the threshold value, the UE may determine a beam failure.

In some implementations, the UE may receive an activation command of the TCI state(s) before the UE receives the cell switch command. The UE may be indicated the TCI state corresponding to the target cell in the cell switch command. The TCI state indicated in the cell switch command may be one of the TCI states activated in the activation command of the TCI state(s). The TCI state(s) indicated in the cell switch command may be applied for the DL channel(s)/signal(s) reception and/or UL channel(s)/signal(s) transmission corresponding to the target cell.

In some implementations, if the UE detects a beam failure corresponding to the beam associated with the TCI state indicated in the cell switch command, the UE may transmit the PRACH to the source cell/gNB in the configured RACH resource according to an SSB configuration of the source cell/gNB. The SSB configuration corresponding to the source cell may be acquired by the previous/stored pre-configuration transmitted by the source cell to the UE before the cell switch command. The RACH resource may be a contention-free random access resource configured in the RRC configuration, a DCI format, and/or the cell switch command.

In some implementations, if the UE detects a beam failure corresponding to the beam associated with the TCI state indicated in the cell switch command, the UE may transmit the PRACH to the target cell or source cell in the configured RACH resource according to the beam used to receive the DCI (or PDCCH) scheduling the cell switch command. The SSB configuration or TCI state associated with the beam used to receive the DCI (or PDCCH) scheduling the cell switch command may be configured to the UE in the RRC (pre-)configuration (e.g., in the RRCReconfiguration message), MAC CE (TCI state activation command), the current cell switch command, and/or the previous cell switch command. The RACH resource may be a contention-free random access resource configured in the RRC (pre-)configuration (e.g., in the RRCReconfiguration message), an RRC configuration, a DCI format, and/or the cell switch command.

In some implementations, if the UE detects a beam failure corresponding to the beam associated with the TCI state indicated in the cell switch command, the UE may transmit the PRACH to the target cell in the configured RACH resource according to an SSB configuration of the target cell. The SSB configuration corresponding to the target cell may be acquired by the previous/stored pre-configuration transmitted by the source cell to the UE before the cell switch command. The RACH resource may be a contention-free random access resource configured in the RRC (pre-)configuration (e.g., in the RRCReconfiguration message), an RRC configuration, a DCI format, and/or the cell switch command.

In some implementations, if the UE detects a beam failure corresponding to the beam associated with the TCI state indicated in the cell switch command, the UE may transmit a MAC CE to the source cell/gNB and/or target cell to inform the source cell/gNB and/or target cell of which TCI state activated in the activation command of the TCI state(s) is applicable for the DL channel(s)/signal(s) reception and/or UL channel(s)/signal(s) transmission corresponding to the target cell. The TCI state indicated in the MAC CE transmitted to the source cell/gNB may be associated with the same PCI value and/or logical value (e.g., the additionalPCIIndex) as the TCI state indicated in the cell switch command.

In some implementations, the UE may be configured with a threshold value by the source cell/gNB to evaluate the beam quality for selecting a new beam. The threshold may be indicated by an RRC parameter/IE/field in the RRC (pre-)configuration or a field in the cell switch command. The threshold value may be the RSRP, RSSI and/or SINR. If the quality of the source RS corresponding to the TCI state(s) activated in the activation command of the TCI state(s) is larger than or equal to the threshold value, the UE may indicate these TCI state(s) in the MAC CE transmitted to the source cell/gNB. These TCI state(s) may be associated with the same PCI value and/or logical value as the target cell.

In some implementations, if the UE detects a beam failure corresponding to the beam associated with the TCI state indicated in the cell switch command, the UE may transmit a MAC CE to the source cell/gNB to inform the source cell/gNB of which TCI state(s) activated in the activation command of the TCI state(s) has good quality. In some implementations, the PCI value and/or logical value (e.g., the additionalPCIIndex) of the TCI state indicated in the MAC CE transmitted to the source cell/gNB may be different from the PCI value and/or logical value (e.g., the additionalPCIIndex) of the TCI state indicated in the cell switch command.

In some implementations, if the PCI value and/or logical value (e.g., the additionalPCIIndex) of the TCI state indicated in the MAC CE transmitted to the source cell/gNB is different from the PCI value and/or logical value (e.g., the additionalPCIIndex) of the TCI state indicated in the cell switch command, the UE may be required to receive a cell switch command that indicates the information/configuration corresponding to a new target cell (e.g., a candidate target cell with the same PCI value and/or logical value as the PCI and/or logical value of the TCI state indicated in the MAC CE).

In some implementations, the UE may be configured with a threshold value by the source cell/gNB to evaluate the beam quality for selecting a new beam. The threshold may be indicated by an RRC parameter/IE/field in the RRC (pre-)configuration (e.g., in the RRCReconfiguration message) or a field in the cell switch command. The threshold value may be the RSRP, RSSI, and/or SINR. If the quality of the source RS corresponding to the TCI state(s) activated in the activation command of the TCI state(s) is larger than or equal to the threshold value, the UE may indicate these TCI state(s) in a MAC CE transmitted to the source cell/gNB.

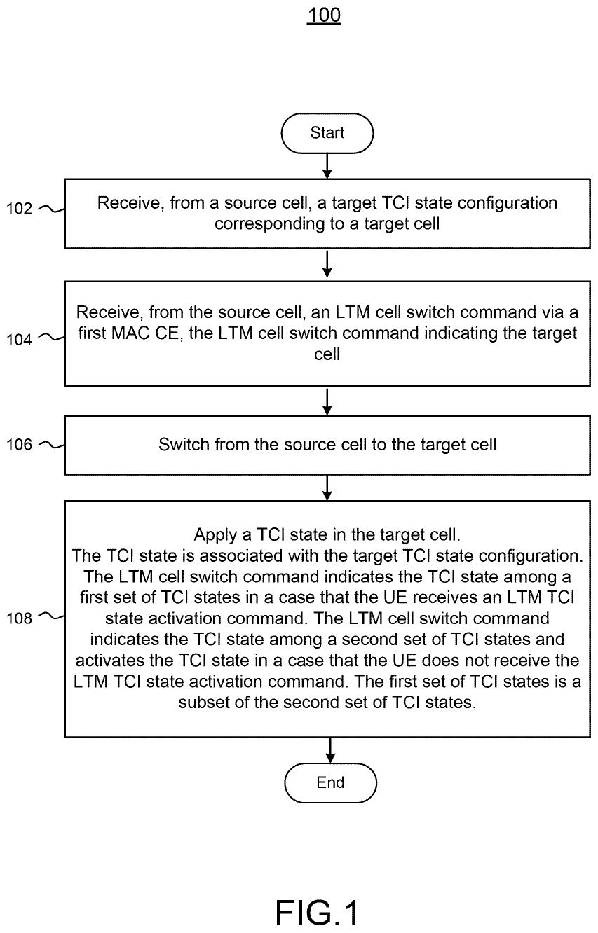

FIG. 1 is a flowchart illustrating a method/process 100 for a UE for performing an LTM operation, according to an example implementation of the present disclosure. In some implementations, the process 100 may be performed by the UE.

In action 102, the process 100 may start by receiving, from a source cell, a target TCI state configuration corresponding to a target cell. In some implementations, for configuring the LTM operation, the source cell may transmit multiple candidate cell configurations to the UE. Each candidate cell configuration may include a candidate TCI state configuration. The target cell may correspond to one of the candidate cell configurations. For example, each candidate TCI state configuration may indicate at least one TCI state to be applied by the UE when the UE performs the LTM operation to switch from the source cell to a corresponding candidate cell. When the UE switches from the source cell to the target cell, the UE may apply at least one TCI state associated with (e.g., included in) the target TCI state configuration.

In action 104, the process 100 may receive, from the source cell, an LTM cell switch command via a first MAC CE. The LTM cell switch command may indicate the target cell. For example, the first MAC CE may include a field for a candidate cell ID. After the UE obtains the candidate cell ID from the first MAC CE, the UE may determine the target cell for the LTM operation.

In action 106, the process 100 may switch from the source cell to the target cell. In action 108, the process 100 may apply a TCI state in the target cell. The process 100 may then end. The TCI state applied by the UE in the target cell may be associated with the target TCI state configuration. The LTM cell switch command may indicate the TCI state among a first set of TCI states in a case that the UE receives an LTM TCI state activation command. The LTM cell switch command may indicate the TCI state among a second set of TCI states and activate the TCI state in a case that the UE does not receive the LTM TCI state activation command. The first set of TCI states may be a subset of the second set of TCI states.

In some implementations, the source cell may transmit the LTM TCI state activation command to the UE. The UE may receive the LTM TCI state activation command via a second MAC CE. The LTM TCI state activation command may activate at least one TCI state (e.g., a subset of TCI states) configured in the target TCI state configuration. For example, there may be 32 TCI states configured in the target TCI state configuration, and the LTM TCI state activation command may activate 8 TCI states among the configured 32 TCI states. It should be noted that the numbers provided here are merely exemplary rather than limiting. The number of configured TCI states and the number of activated TCI states may vary in different implementations. For instance, the number of configured TCI states may be 64, and the number of activated TCI states may be 4. In some implementations, the LTM TCI state activation command may be received before the LTM cell switch command is received.

If the UE successfully receives the LTM TCI state activation command, the LTM TCI state activation command may activate the first set of TCI states (e.g., 8 TCI states) among all TCI states (e.g., 32 TCI states) configured in the target TCI state configuration, and the LTM cell switch command may indicate the TCI state among the first set of TCI states. For example, the LTM cell switch command may indicate one or two TCI states (e.g., depending on the separate or joint TCI mode) among the activated 8 TCI states.

If the UE does not successfully receive the LTM TCI state activation command (e.g., because the source cell does not transmit the LTM TCI state activation command or the UE fails to receive the LTM TCI state activation command transmitted by the source cell), the LTM cell switch command may indicate the TCI state among a second set of TCI states and activate the TCI state, where the second set of TCI states may include all TCI states (e.g., 32 TCI states) configured in the target TCI state configuration. For example, the LTM cell switch command may indicate one or two TCI states (e.g., depending on the separate or joint TCI mode) among the configured 32 TCI states and activate the one or two TCI states. In other words, even if the target TCI state has not been activated when receiving the LTM cell switch command, the UE may still properly perform the LTM operation because the LTM cell switch command activates and indicates the target TCI state.

In some implementations, the TCI state may be applied by the UE no later than a time duration after the last symbol of a PUCCH or a PUSCH with HARQ-ACK information of a PDSCH providing the LTM cell switch command. In some implementations, the time duration may be independent of whether the UE successfully receives the LTM TCI state activation command before receiving the LTM cell switch command. In some implementations, the time duration may vary depending on whether the UE successfully receives the LTM TCI state activation command before receiving the LTM cell switch command. For example, the time duration may be longer if the UE does not successfully receive the LTM TCI state activation command.

In some implementations, the target TCI state configuration may include a parameter for indicating a separate TCI mode or a joint TCI mode. For example, if the joint TCI mode is indicated, the UE may apply one TCI state for both DL and UL in the target cell. If the separate TCI mode is indicated, the UE may apply two TCI states, including one DL TCI state and one UL TCI state, in the target cell.

The steps/actions shown in FIG. 1 should not be construed as necessarily order dependent. The order in which the process is described is not intended to be construed as a limitation. Moreover, some of the actions in FIG. 1 may be omitted in some implementations.

The technical problem addressed by the method illustrated in FIG. 1 is how to efficiently perform an LTM operation, which includes providing a candidate TCI state configuration per candidate cell and providing an LTM cell switch command with flexible functionality. Because the TCI state for the LTM operation is configured per candidate cell, after selecting the target cell, the UE may quickly find the corresponding TCI state configuration. In addition, the flexibility of the LTM cell switch command shown in FIG. 1 allows the UE to quickly identify which TCI state to apply in the target cell, regardless of whether the UE receives the LTM TCI state activation command from the source cell. This method may help to improve the overall performance of the wireless communication system by reducing the signaling overhead and processing time, leading to enhanced LTM operation performance.

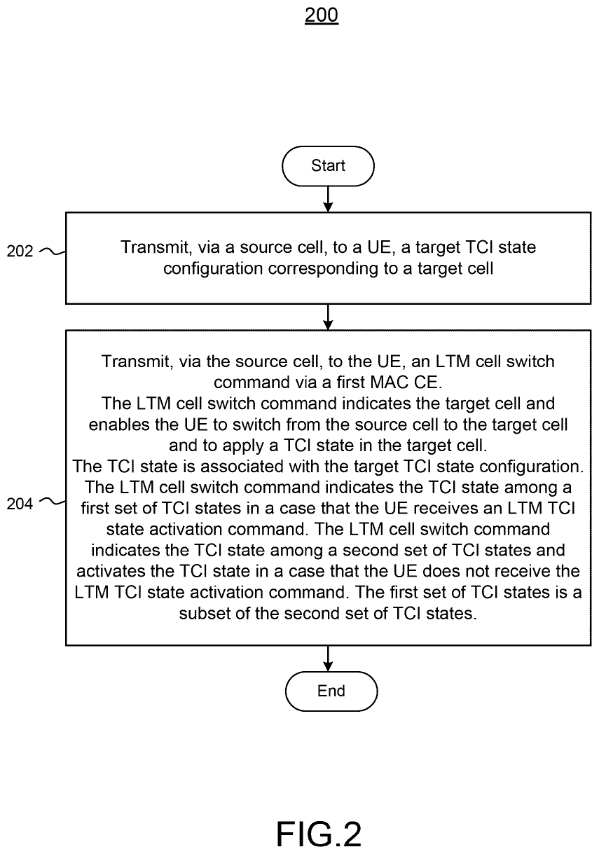

FIG. 2 is a flowchart illustrating a method/process 200 performed by a BS for configuring the LTM, according to an example implementation of the present disclosure. In some implementations, the process 200 may be performed by the BS.

In action 202, the process 200 may start by transmitting, via a source cell, to a UE, a target TCI state configuration corresponding to a target cell. In action 204, the process 200 may transmit, via the source cell, to the UE, an LTM cell switch command via a first MAC CE. The LTM cell switch command may indicate the target cell and enable the UE to switch from the source cell to the target cell and to apply a TCI state in the target cell. The process 200 may then end.

The TCI state may be associated with the target TCI state configuration. The LTM cell switch command may indicate the TCI state among a first set of TCI states in a case that the UE receives an LTM TCI state activation command. The LTM cell switch command may indicate the TCI state among a second set of TCI states and activate the TCI state in a case that the UE does not receive the LTM TCI state activation command. The first set of TCI states may be a subset of the second set of TCI states.

The method illustrated in FIG. 2 is similar to that in FIG. 1, except that it is described from the perspective of the BS.

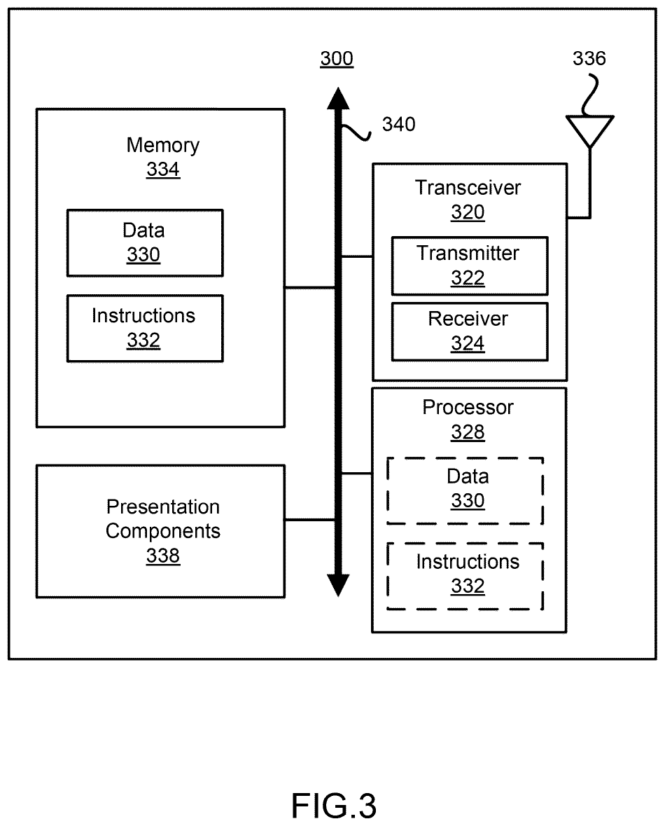

FIG. 3 is a block diagram illustrating a node 300 for wireless communication in accordance with various aspects of the present disclosure. As illustrated in FIG. 3, a node 300 may include a transceiver 320, a processor 328, a memory 334, one or more presentation components 338, and at least one antenna 336. The node 300 may also include a radio frequency (RF) spectrum band module, a BS communications module, a network communications module, and a system communications management module, Input/Output (I/O) ports, I/O components, and a power supply (not illustrated in FIG. 3).

Each of the components may directly or indirectly communicate with each other over one or more buses 340. The node 300 may be a UE or a BS that performs various functions disclosed with reference to FIGS. 1 through 2.

The transceiver 320 has a transmitter 322 (e.g., transmitting/transmission circuitry) and a receiver 324 (e.g., receiving/reception circuitry) and may be configured to transmit and/or receive time and/or frequency resource partitioning information. The transceiver 320 may be configured to transmit in different types of subframes and slots including, but not limited to, usable, non-usable, and flexibly usable subframes and slot formats. The transceiver 320 may be configured to receive data and control channels.

The node 300 may include a variety of computer-readable media. Computer-readable media may be any available media that may be accessed by the node 300 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the above listed components should also be included within the scope of computer-readable media.

The memory 334 may include computer-storage media in the form of volatile and/or non-volatile memory. The memory 334 may be removable, non-removable, or a combination thereof. Example memory may include solid-state memory, hard drives, optical-disc drives, etc. As illustrated in FIG. 3, the memory 334 may store a computer-readable and/or computer-executable instructions 332 (e.g., software codes) that are configured to, when executed, cause the processor 328 to perform various functions disclosed herein, for example, with reference to FIGS. 1 through 2. Alternatively, the instructions 332 may not be directly executable by the processor 328 but may be configured to cause the node 300 (e.g., when compiled and executed) to perform various functions disclosed herein.

The processor 328 (e.g., having processing circuitry) may include an intelligent hardware device, e.g., a Central Processing Unit (CPU), a microcontroller, an ASIC, etc. The processor 328 may include memory. The processor 328 may process the data 330 and the instructions 332 received from the memory 334, and information transmitted and received via the transceiver 320, the baseband communications module, and/or the network communications module. The processor 328 may also process information to send to the transceiver 320 for transmission via the antenna 336 to the network communications module for transmission to a CN.

One or more presentation components 338 may present data indications to a person or another device. Examples of presentation components 338 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

What is claimed is:

1. A method for a User Equipment (UE) for performing a Layer1/Layer2 Triggered Mobility (LTM) operation, the method comprising:
receiving, from a source cell, a target Transmission Configuration Indicator (TCI) state configuration corresponding to a target cell;
receiving, from the source cell, an LTM cell switch command via a first Medium Access Control (MAC) Control Element (CE), the LTM cell switch command indicating the target cell;
switching from the source cell to the target cell; and
applying a TCI state in the target cell, wherein:
the TCI state is associated with the target TCI state configuration,
the LTM cell switch command indicates the TCI state among a first set of TCI states in a case that the UE receives an LTM TCI state activation command,
the LTM cell switch command indicates the TCI state among a second set of TCI states and activates the TCI state in a case that the UE does not receive the LTM TCI state activation command, and
the first set of TCI states is a subset of the second set of TCI states.

2. The method of claim 1, further comprising receiving, from the source cell, a plurality of candidate cell configurations, wherein:
each of the plurality of candidate cell configurations comprises a candidate TCI state configuration, and
the target cell corresponds to one of the plurality of candidate cell configurations.

3. The method of claim 1, wherein:
the TCI state is applied no later than a time duration after the last symbol of a Physical Uplink Control Channel (PUCCH) or a Physical Uplink Shared Channel (PUSCH) with Hybrid Automatic Repeat Request-Acknowledgement (HARQ-ACK) information of a Physical Downlink Shared Channel (PDSCH) providing the LTM cell switch command.

4. The method of claim 1, wherein:
the second set of TCI states comprises all TCI states configured in the target TCI state configuration.

5. The method of claim 1, wherein:
the LTM TCI state activation command is received via a second MAC CE, and
the LTM TCI state activation command activates the first set of TCI states among all TCI states configured in the target TCI state configuration.

6. The method of claim 1, wherein:
the LTM TCI state activation command is received before the LTM cell switch command is received.

7. The method of claim 1, wherein the target TCI state configuration comprises a parameter for indicating a separate TCI mode or a joint TCI mode.

8. A User Equipment (UE) for performing a Layer1/Layer2 Triggered Mobility (LTM) operation, the UE comprising:
at least one processor; and
at least one non-transitory computer-readable medium coupled to the at least one processor and storing one or more computer-executable instructions that, when executed by the at least one processor, cause the UE to:
receive, from a source cell, a target Transmission Configuration Indicator (TCI) state configuration corresponding to a target cell;
receive, from the source cell, an LTM cell switch command via a first Medium Access Control (MAC) Control Element (CE), the LTM cell switch command indicating the target cell;
switch from the source cell to the target cell; and
apply a TCI state in the target cell, wherein:
the TCI state is associated with the target TCI state configuration,
the LTM cell switch command indicates the TCI state among a first set of TCI states in a case that the UE receives an LTM TCI state activation command,
the LTM cell switch command indicates the TCI state among a second set of TCI states and activates the TCI state in a case that the UE does not receive the LTM TCI state activation command, and
the first set of TCI states is a subset of the second set of TCI states.

9. The UE of claim 8, wherein the one or more computer-executable instructions, when executed by the at least one processor, further cause the UE to:
receive, from the source cell, a plurality of candidate cell configurations, wherein:
each of the plurality of candidate cell configurations comprises a candidate TCI state configuration, and
the target cell corresponds to one of the plurality of candidate cell configurations.

10. The UE of claim 8, wherein:
the TCI state is applied no later than a time duration after the last symbol of a Physical Uplink Control Channel (PUCCH) or a Physical Uplink Shared Channel (PUSCH) with Hybrid Automatic Repeat Request-Acknowledgement (HARQ-ACK) information of a Physical Downlink Shared Channel (PDSCH) providing the LTM cell switch command.

11. The UE of claim 8, wherein:
the second set of TCI states comprises all TCI states configured in the target TCI state configuration.

12. The UE of claim 8, wherein:
the LTM TCI state activation command is received via a second MAC CE, and
the LTM TCI state activation command activates the first set of TCI states among all TCI states configured in the target TCI state configuration.

13. The UE of claim 8, wherein:
the LTM TCI state activation command is received before the LTM cell switch command is received.

14. The UE of claim 8, wherein the target TCI state configuration comprises a parameter for indicating a separate TCI mode or a joint TCI mode.

15. A Base Station (BS) for configuring a Layer1/Layer2 Triggered Mobility (LTM) operation, the BS comprising:
at least one processor; and
at least one non-transitory computer-readable medium coupled to the at least one processor and storing one or more computer-executable instructions that, when executed by the at least one processor, cause the BS to:
transmit, via a source cell, to a user equipment (UE), a target Transmission Configuration Indicator (TCI) state configuration corresponding to a target cell; and
transmit, via the source cell, to the UE, an LTM cell switch command via a first Medium Access Control (MAC) Control Element (CE), the LTM cell switch command indicating the target cell and enabling the UE to switch from the source cell to the target cell and to apply a TCI state in the target cell, wherein:
the TCI state is associated with the target TCI state configuration,
the LTM cell switch command indicates the TCI state among a first set of TCI states in a case that the UE receives an LTM TCI state activation command,
the LTM cell switch command indicates the TCI state among a second set of TCI states and activates the TCI state in a case that the UE does not receive the LTM TCI state activation command, and
the first set of TCI states is a subset of the second set of TCI states.

16. The BS of claim 15, wherein the one or more computer-executable instructions, when executed by the at least one processor, further cause the BS to:
transmit, via the source cell, to the UE, a plurality of candidate cell configurations, wherein:
each of the plurality of candidate cell configurations comprises a candidate TCI state configuration, and
the target cell corresponds to one of the plurality of candidate cell configurations.

17. The BS of claim 15, wherein:
the UE applies the TCI state no later than a time duration after the last symbol of a Physical Uplink Control Channel (PUCCH) or a Physical Uplink Shared Channel (PUSCH) with Hybrid Automatic Repeat Request-Acknowledgement (HARQ-ACK) information of a Physical Downlink Shared Channel (PDSCH) providing the LTM cell switch command.

18. The BS of claim 15, wherein:
the second set of TCI states comprises all TCI states configured in the target TCI state configuration.

19. The BS of claim 15, wherein:
the LTM TCI state activation command is transmitted via a second MAC CE, and
the LTM TCI state activation command activates the first set of TCI states among all TCI states configured in the target TCI state configuration.

20. The BS of claim 15, wherein the target TCI state configuration comprises a parameter for indicating a separate TCI mode or a joint TCI mode.
